(19) United States
(12) Patent Application Publication
(10) Pub. No.: US 2020/0356938 A1
(43) Pub. Date: Nov. 12, 2020

(54) System and Method for Verifying Organically Distributed Digital and Social Media Content

(71) Applicant: Intensify Social, LLC, Clarkston, MI (US)

(72) Inventors: Stephen Sadler, Clarkston, MI (US); Noelle Laurie Hoenle, Lake Orion, MI (US)

(73) Assignee: Intensify Social, LLC, Clarkston, MI (US)

(21) Appl. No.: 16/871,668

(22) Filed: May 11, 2020

Related U.S. Application Data
(60) Provisional application No. 62/845,740, filed on May 9, 2019.

(51) Int. Cl. G06Q 10/06; G06Q 50/00; G06Q 30/02; H04L 12/58

(52) U.S. Cl. CPC G06Q 10/063114; G06Q 50/01; G06Q 10/105; H04L 51/32; G06Q 30/0274

(57) ABSTRACT

Systems and methods are described that utilize an integration of formulas, algorithms, databases, and interactive interfaces for use in digital marketing campaigns and/or the like. The systems and methods can be used to efficiently create, manage and/or coordinate digital content posts over organic social media outlets. The features of the systems and methods enable the content creator to upload, schedule and send media content to influencers to be posted across influencer's social channels and spheres of influence. The content creator can manage a large number of different accounts, social media campaigns, and influencers, that heretofore has been insecure, laborious and time consuming to accomplish with conventional means. Verification (digital proof) technology allows campaign managers to leverage free and paid influencers to securely increase the digital footprint of their content, while provide influencers with a secure place to access content and receive compensation for posting.

### CROSS-REFERENCE TO RELATED APPLICATION

The instant application claims priority to U.S. Provisional Patent Application Ser. No. 62/845,740, filed May 9, 2019, the entire specification of which is expressly incorporated herein by reference.

### FIELD OF THE INVENTION

The present invention relates generally to digital marketing, and more particularly to systems and methods for allowing users to easily manage content marketers, also known as digital influencers.

### SUMMARY OF THE INVENTION

In accordance with one embodiment of the present invention, a method is provided for verifying posts by influencers that were tasked to them during a campaign, comprising:

tasking the sharing of a post;

verifying the sharing of a post;

optionally, tracking the performance of a post; and

optionally, compensating the sharing of a post.

In accordance with another embodiment of the present invention, a system is provided for verifying posts by influencers that were tasked to them during a campaign, comprising:

a tasking system for the sharing of a post;

a verifying system for verifying the sharing of a post;

optionally, a tracking system for tracking the performance of a post; and

optionally, a compensating system for compensating the sharing of a post.

The details of one or more implementations of the present invention are set forth in the accompanying drawings and the description below. Other features and advantages of the invention will become apparent from the description, the drawings, and the claims.

### BRIEF DESCRIPTION OF THE DRAWINGS

The present invention will become more fully understood from the detailed description and the accompanying drawings, wherein:

FIGS. 1-2 are schematic illustrations of system and/or method flowcharts in accordance with the general teachings of the present invention; and

FIGS. 3-10 are illustrative screen captures showing various system views in accordance with the general teachings of the present invention.

### DETAILED DESCRIPTION OF THE INVENTION

The present invention is the integration of formulas, algorithms, databases, and interactive interfaces. The technology results in an application that lets users build digital and social campaigns.

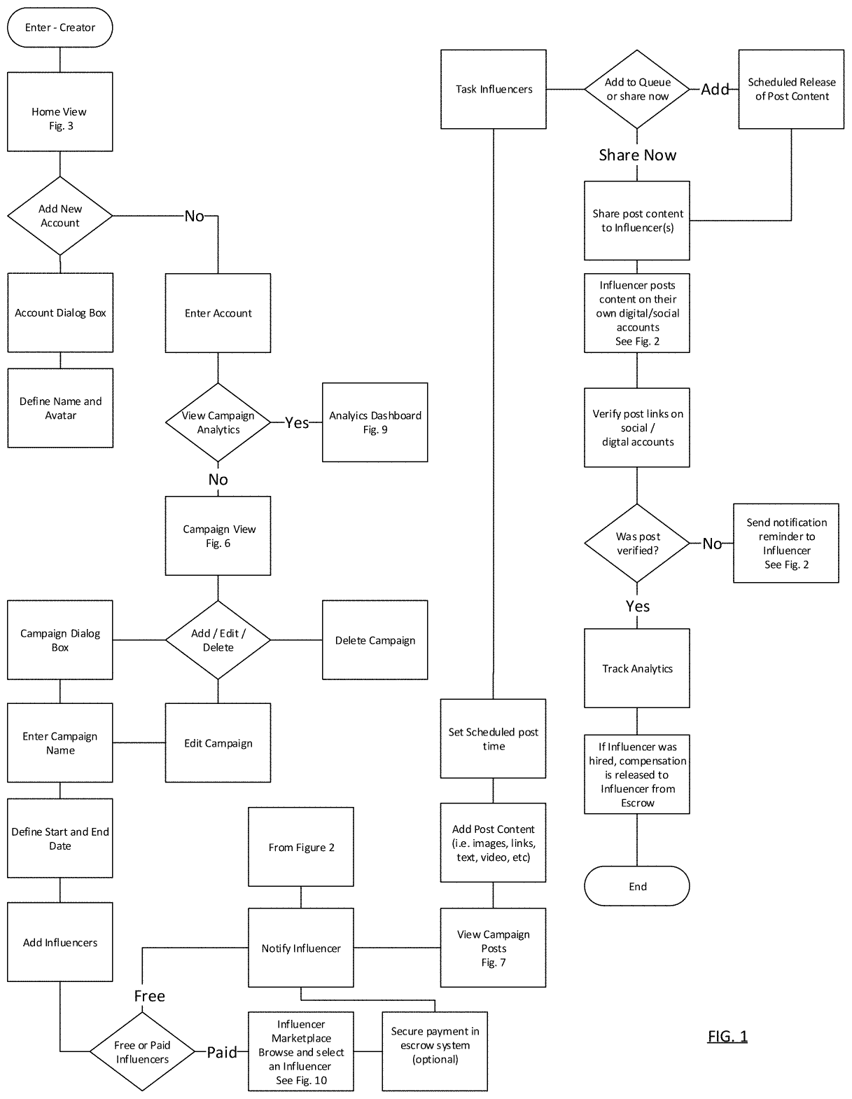

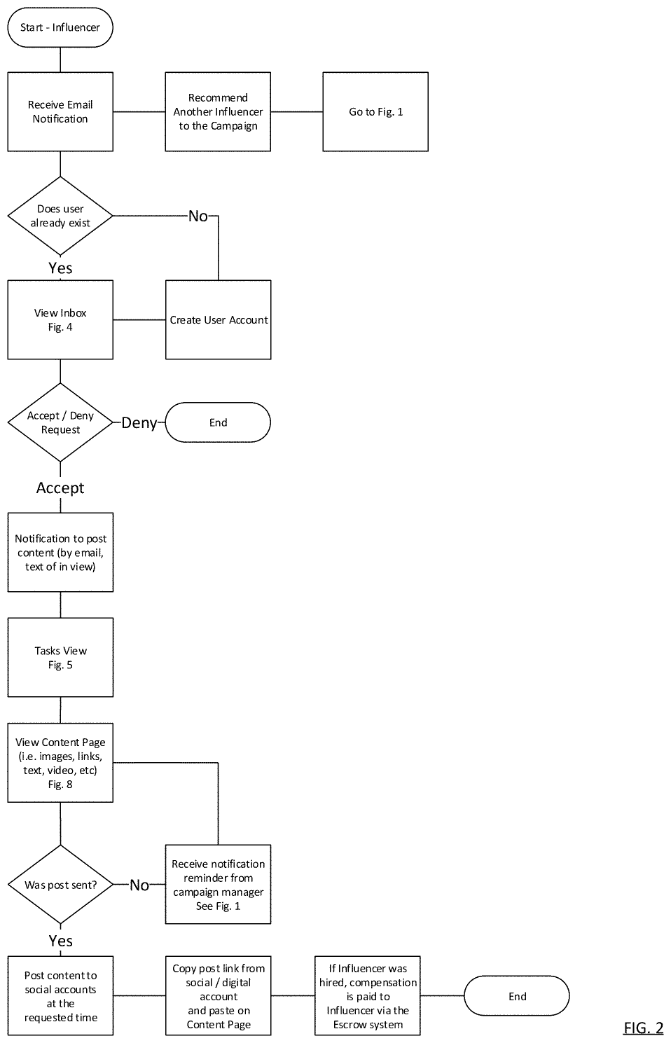

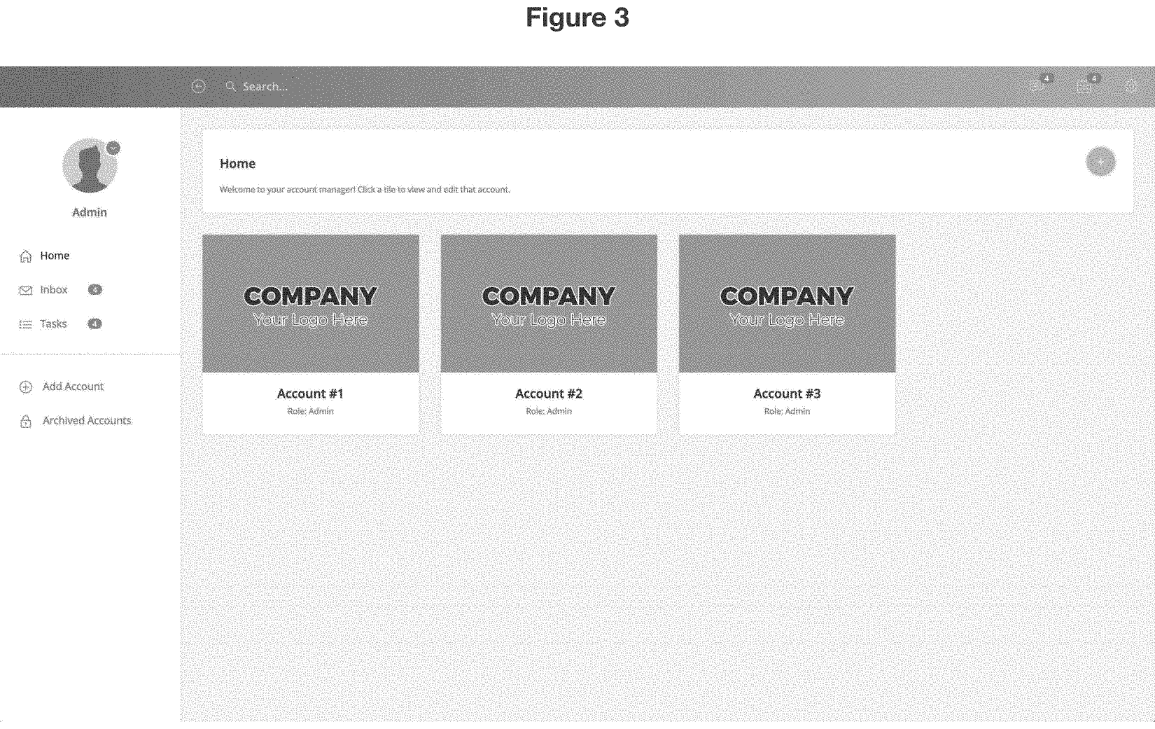

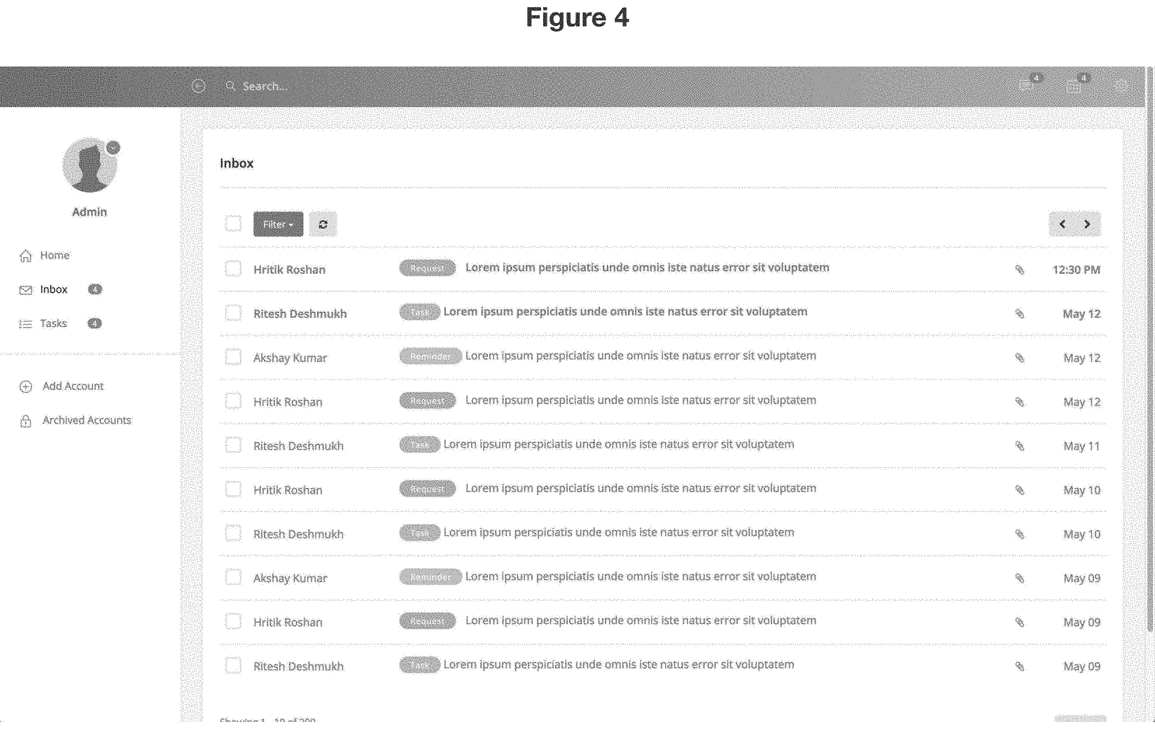

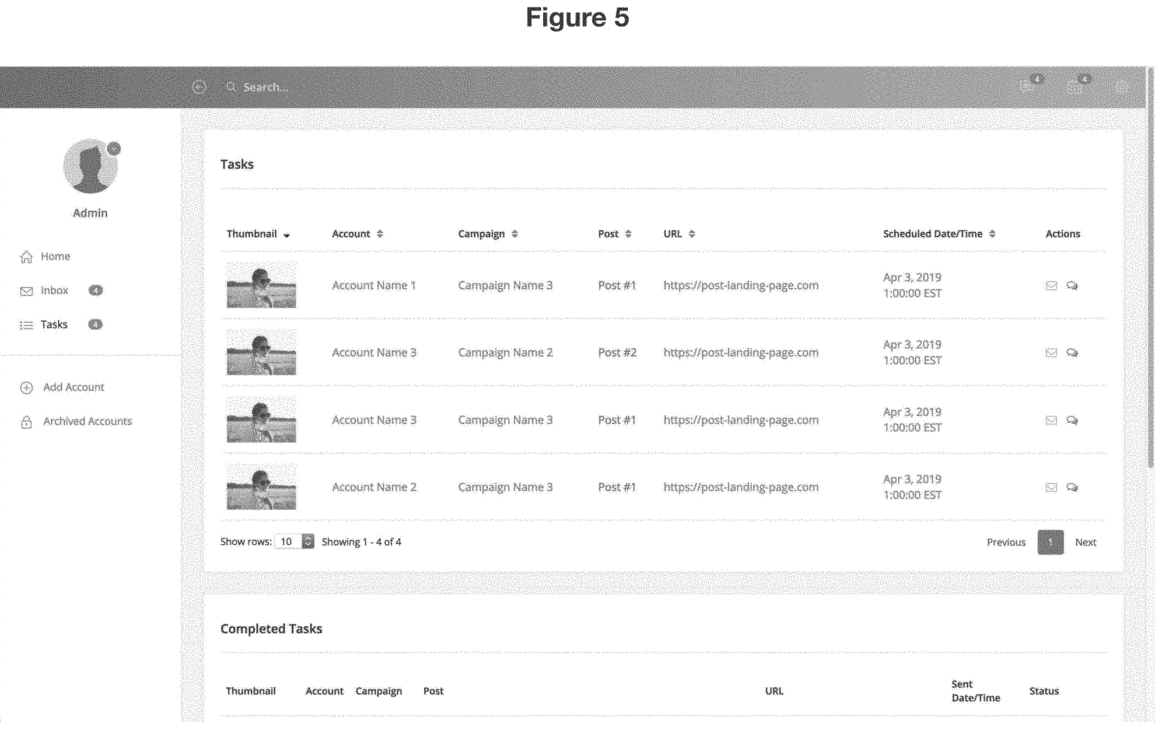

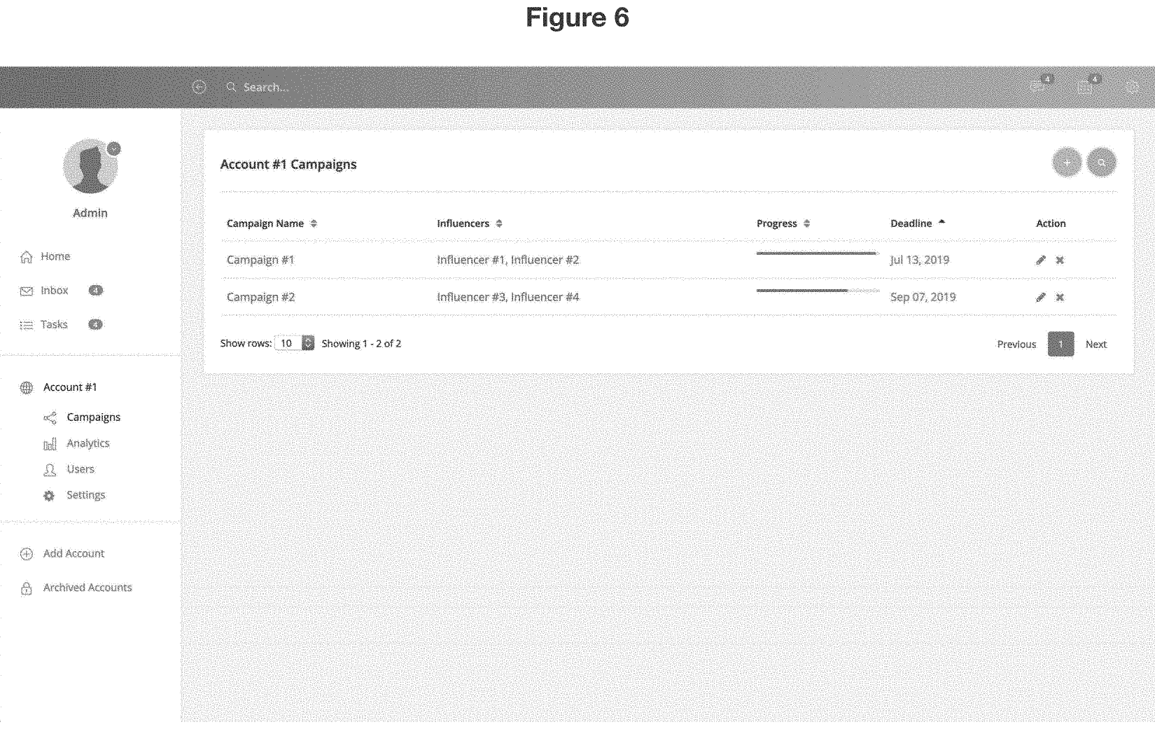

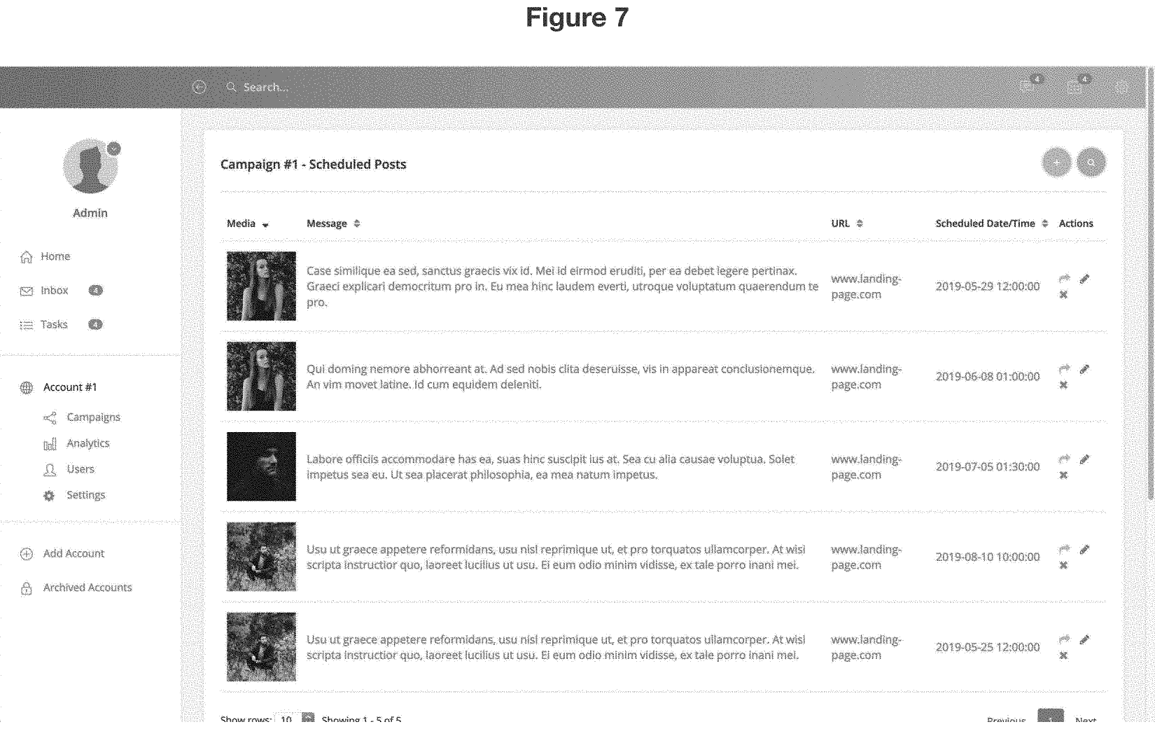

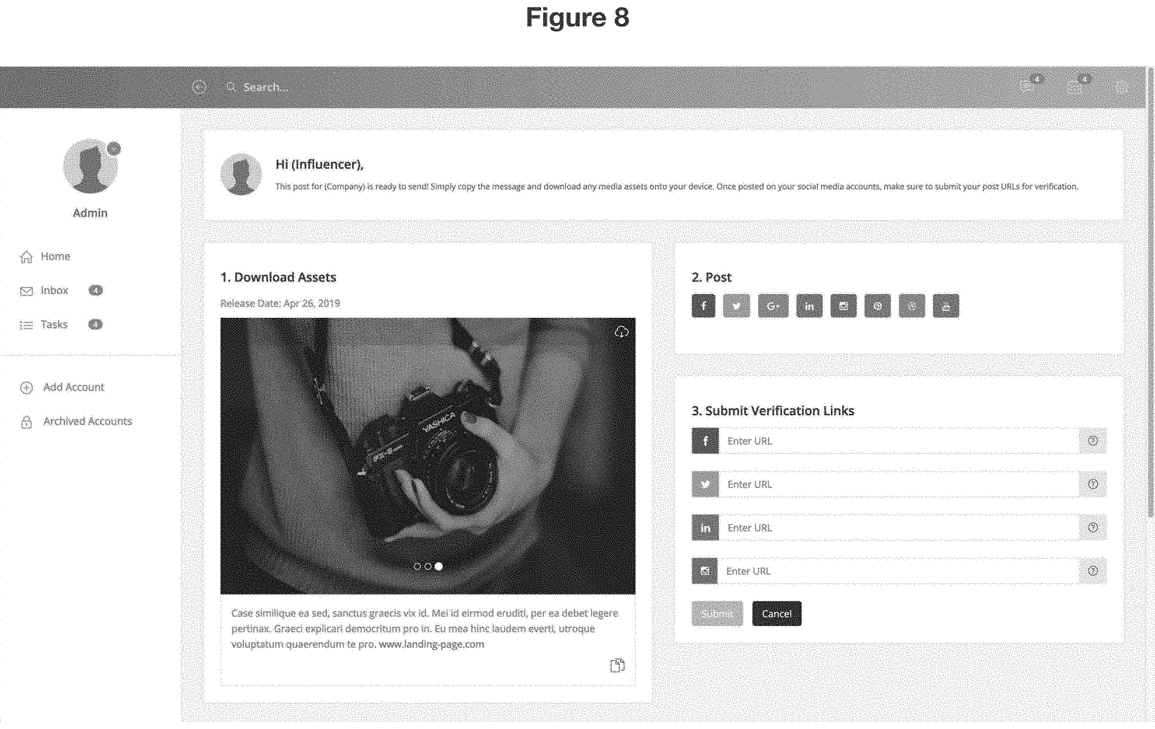

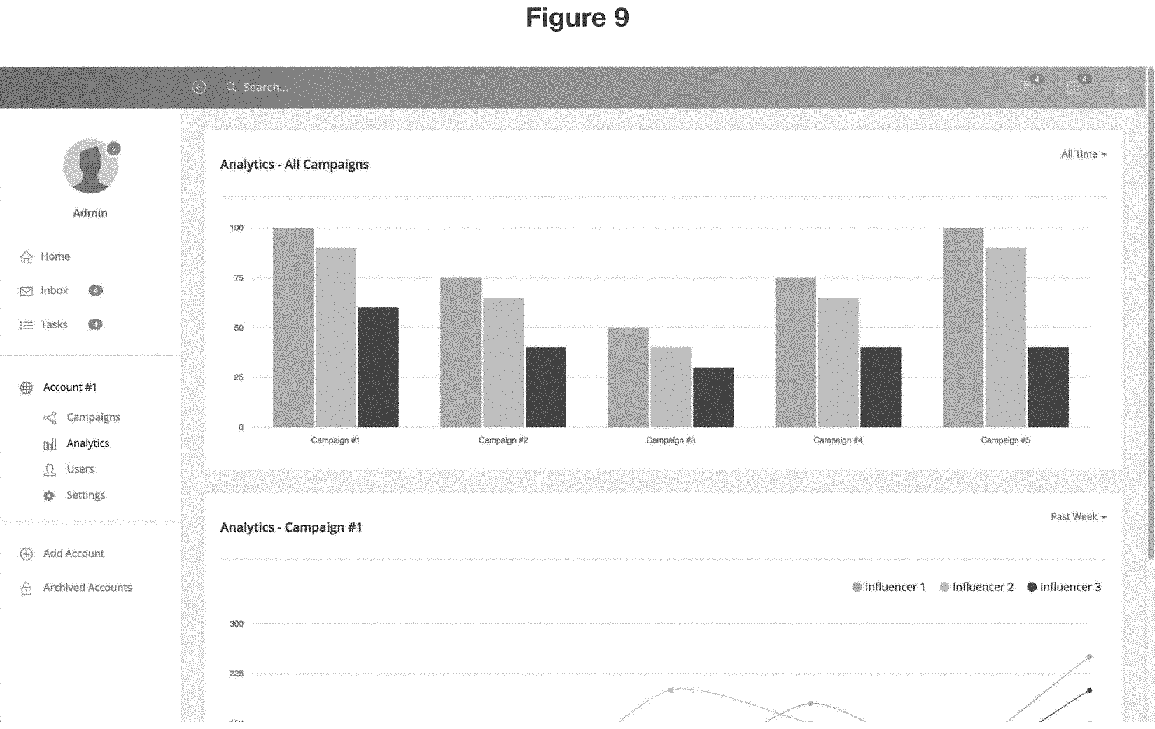

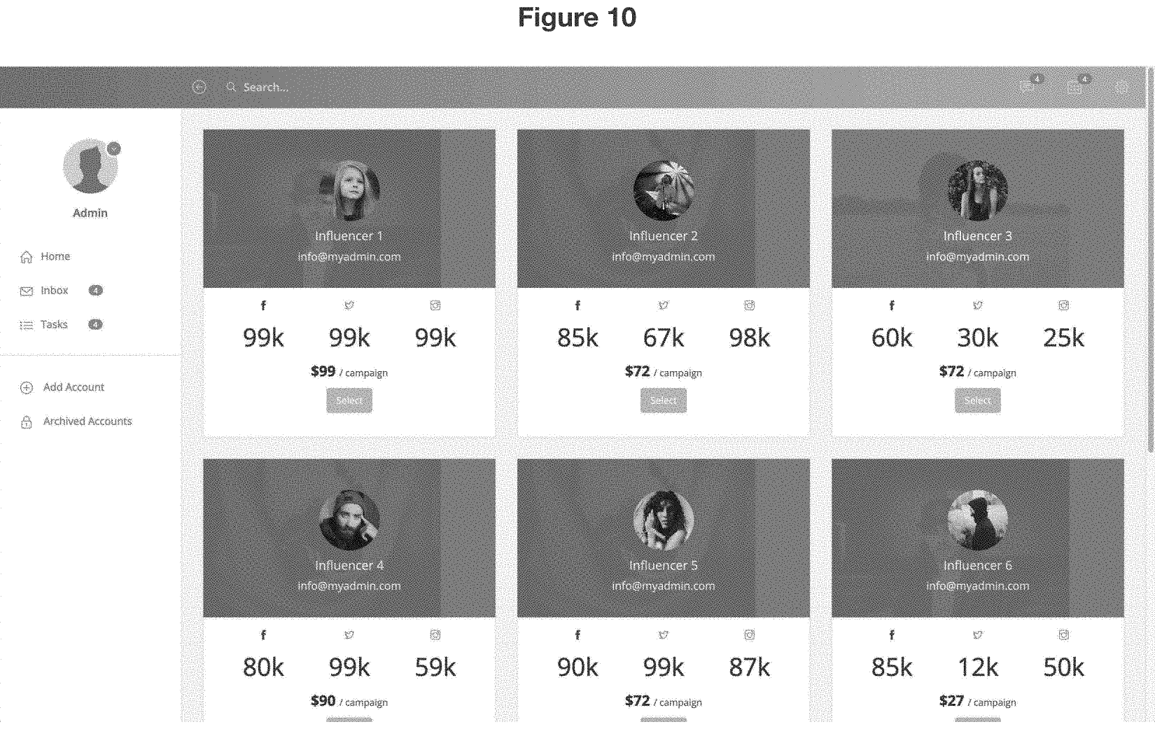

Referring generally to FIGS. 1-10, the present invention enables users to provide content in any format to influencers to be released at a specific time. A notification system delivers the content to the influencer in a format that is easy to send across any of their influential digital networks such as web, social, and/or mobile.

Influencers can be added to a campaign by a campaign manager. A task-verification system and a secure-payment escrow system are used to protect both influencers and campaign managers. The task verification system allows influencers to digitally prove they have completed the task, while the escrow system holds the money until verification is complete.

Influencers can also be placed in a “marketplace” where campaign managers can find and hire them for digital campaigns based their digital footprint and area of influence.

In some applications, the present invention described above may be provided as elements of an integrated software system, in which the features may be provided as separate elements of a computer program. Some embodiments may be implemented, for example, using a computer-readable storage medium (e.g., non-transitory) or article which may store an instruction or a set of instructions that, if executed by a processor, may cause the processor to perform a method in accordance with the embodiments. Other applications of the present invention may be embodied as a hybrid system of dedicated hardware and software components. Moreover, not all of the features described above need be provided or need be provided as separate units. Additionally, it is noted that the arrangement of the features do not necessarily imply a particular order or sequence of events, nor are they intended to exclude other possibilities. For example, the features may occur in any order or substantially simultaneously with each other. Such implementation details are immaterial to the operation of the present invention unless otherwise noted above.

The exemplary methods and computer program instructions may be embodied on a computer readable storage medium (e.g., non-transitory) that may include any medium that can store information. Examples of a computer readable storage medium (e.g., non-transitory) include electronic circuits, semiconductor memory devices, ROM, flash memory, erasable ROM (EROM), floppy diskette, CD-ROM, optical disk, hard disk, fiber optic medium, or any electromagnetic or optical storage device. In addition, a server or database server may include computer readable media configured to store executable program instructions. The features of the embodiments of the present invention may be implemented in hardware, software, firmware, or a combination thereof and utilized in systems, subsystems, components or subcomponents thereof.

Furthermore, a software program embodying the features of the present invention may be used in conjunction with a computer device or system. Examples of a computing device or system may include, but are not limited to, an electronic book reading device, a computer workstation, a terminal computer, a server computer, a handheld or mobile device (e.g., a tablet computer, a personal digital assistant “PDA”, a mobile telephone, a Smartphone, etc.), a web appliance, a network router, a network switch, a network bridge, any machine capable of executing a sequence of instructions that specify an action to be taken by that machine, and any combinations thereof. In one example, a computing device may include and/or be included in, a kiosk.

As used herein, the term “mobile device” is intended to encompass any form of programmable computing device as may exist, or will be developed in the future, that implements a communication module for wireless voice and data communications, including, for example, cellular telephones, personal data assistants (PDA's), palm-top computers, laptop, and notebook computers, wireless electronic mail receivers (e.g., the BLACKBERRY™ and TREO™ devices), multimedia Internet enabled cellular telephones (e.g., the BLACKBERRY STORM™, and similar personal electronic devices that include a wireless communication module, processor and memory.

The computer device or system may also include an input device. In one example, a user of the computer device or system may enter commands and/or other information into computer device or system via an input device. Examples of an input device may include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), touchscreen, and any combinations thereof. The input device may be interfaced to bus via any of a variety of interfaces including, but not limited to, a serial interface, a parallel interface, a game port, a USB interface, a FIREWIRE interface, a direct interface to bus, and any combinations thereof. The input device may include a touch screen interface that may be a part of or separate from the display.

A user may also input commands and/or other information to the computer device or system via a storage device (e.g., a removable disk drive, a flash drive, etc.) and/or a network interface device. A network interface device, such as network interface device may be utilized for connecting the computer device or system to one or more of a variety of networks and/or one or more remote devices connected thereto. Examples of a network interface device may include, but are not limited to, a network interface card (e.g., a mobile network interface card, a LAN card), a modem, and any combination thereof. Examples of a network may include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software, etc.) may be communicated to and/or from the computer device or system via a network interface device.

The computer device or system may further include a video display adapter for communicating a displayable image to a display device, such as a display device. Examples of a display device may include, but are not limited to, a liquid crystal display (LCD), a cathode ray tube (CRT), a plasma display, a light emitting diode (LED) display, and any combinations thereof. In addition to a display device, the computer device or system may include one or more other peripheral output devices including, but not limited to, an audio speaker, a printer, and any combinations thereof. Such peripheral output devices may be connected to a bus via a peripheral interface. Examples of a peripheral interface may include, but are not limited to, a serial port, a USB connection, a FIREWIRE connection, a parallel connection, and any combinations thereof.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method for verifying posts by influencers that were tasked to them during a campaign, comprising:
tasking the sharing of a post;
verifying the sharing of a post;
optionally, tracking the performance of a post; and
optionally, compensating the sharing of a post.

2. A system for verifying posts by influencers that were tasked to them during a campaign, comprising:
a tasking system for the sharing of a post;
a verifying system for verifying the sharing of a post;
optionally, a tracking system for tracking the performance of a post; and
optionally, a compensating system for compensating the sharing of a post.
